(19) United States
(12) Patent Application Publication
(10) Pub. No.: US 2016/0113215 A1
(43) Pub. Date: Apr. 28, 2016

(54) METHODS FOR AMELIORATING WATER SHORTAGES AND DROUGHT CONDITIONS USING INDUCED PRECIPITATION RECYCLING

(71) Applicant: Kevin Layton, Torrance, CA (US)

(72) Inventor: Kevin Layton, Torrance, CA (US)

(21) Appl. No.: 14/923,244

(22) Filed: Oct. 26, 2015

Related U.S. Application Data
(60) Provisional application No. 62/068,580, filed on Oct. 24, 2014.

(51) Int. Cl. A01G 15/00; E03B 11/10; E02B 13/00; A01C 14/00; A01G 25/16

(52) U.S. Cl. CPC A01G 15/00; A01C 14/00; A01G 25/16; E02B 13/00; E03B 11/10

(57) ABSTRACT

Embodiments of the present disclosure provide materials and methods for induced precipitation recycling, including establishing afforestation plots and harvesting natural resources. Certain embodiments disclosed herein include targeted development and implementation of an environmentally sustainable precipitation recycling program to ameliorate chronic regional water shortages and drought conditions. In other embodiments, methods and systems disclosed provide for synergistic ecological benefits, including, but not limited to, methods for wastewater treatment, carbon sequestration, storm water management, groundwater recharge and phytoremediation.

### RELATED APPLICATIONS

The instant application claims the benefit of U.S. Provisional Patent Application Ser. No. 62/068,580, filed Oct. 24, 2014. This application is incorporated herein by reference in its entirety for all purposes.

### FIELD

Embodiments of the present disclosure provide materials and methods for inducing precipitation capture and/or recycling. Certain embodiments disclosed herein can include establishing afforestation plots and harvesting natural resources from the plots. Other embodiments herein can include targeted development and implementation of an environmentally sustainable precipitation recycling program to ameliorate acute and chronic regional water shortages and drought conditions.

### BACKGROUND

Chronic regional water shortages are a significant concern throughout the world, including the western United States. Around 1.2 billion people, or almost one-fifth of the world's population, live in geographies where water shortages exist, and 500 million more people have been identified as being increasingly vulnerable to water shortages in the future. Another 1.6 billion people, or almost one quarter of the world's population, face economic water shortage (i.e., lack of infrastructure to transport water from rivers and aquifers). Additionally, water use has been growing at more than twice the rate of population increase in the last century, exacerbating already existing water shortages. Water shortages are both a natural and a human-made phenomenon. Though there is enough freshwater on the planet for seven billion people, it is distributed unevenly and too much of it is wasted, polluted and unsustainably managed.

The challenges and complexities of ensuring a sustainable water supply and meeting future demand have been recognized and documented in numerous studies over the past several decades. Currently proposed solutions involve importing water from other regions, conservation or improved management of currently limited available water supplies, and wastewater treatment or desalination of otherwise unusable water sources. However, most of these approaches fail to integrate observed natural interactions and processes occurring between forested land and the hydrologic cycle, which offer the potential to ameliorate chronic regional water shortages in an environmentally sustainable and synergistic manner. For example, “precipitation recycling” (PR) and the “biotic pump” (BP) describe concepts which are at the center of the link between the hydrologic cycle and forested land. PR, which has been defined as the contribution of local evaporation to local precipitation, aims at understanding hydrologic processes in the atmospheric branch of the water cycle. BP is a concept that attributes to the world's forests a major role in driving precipitation from coastal regions to inland regions, and it involves the creation of a low pressure region over forests that help draws moisture-laden air thousands of miles to the interior of a continent.

Given the current water shortages throughout the world, as well as the likelihood that these shortages will increase in the future, alternative approaches to increasing regional precipitation are necessary. These alternative approaches may not only ameliorate regional water shortages by harnessing existing environmental processes, but may also provide synergistic ecological benefits, including for example, means for wastewater treatment, carbon sequestration, storm water management, groundwater recharge, and phytoremediation.

### SUMMARY

Embodiments of the present disclosure provide materials and methods for inducing precipitation capture and/or recycling. Certain embodiments disclosed herein can include establishing afforestation plots and harvesting natural resources from the plots. Other embodiments herein can include targeted development and implementation of an environmentally sustainable precipitation recycling program to ameliorate acute and chronic regional water shortages and drought conditions.

Embodiments disclosed herein provide for methods of inducing precipitation capture and/or recycling. In accordance with these embodiments, these methods can include identifying one or more regions that experience acute or chronic water shortages or chronic drought conditions, selecting one or more subregions to be targeted for inducing precipitation capture and/or recycling from the one or more regions based on certain criteria, establishing one or more afforestation plots comprising a plurality of plants on at least a portion of the selected subregions, providing one or more irrigation sources for facilitating the growth of the plurality of plants in the selected subregions, and/or harvesting one or more natural resources from the selected subregions.

Embodiments can also include selection of a predetermined set of criteria used to determine the one or more subregions to be targeted for induced precipitation recycling. Suitable selection criteria can include, but is not limited to, one or more of proximity to a body of water, amount of vegetation present, proximity to an urban center, proximity to a hillside or mountain, proximity to an irrigation source, elevation, relative humidity, average annual rainfall, soil composition, water runoff characteristics, weather patterns, surface temperature, current utilization of land in the subregion, political stability, and/or economic stability.

Establishing one or more afforestation plots according to methods disclosed herein can include planting a plurality of plants on at least a portion of one or more subregions having no vegetation, establishing one or more afforestation plots on a subregion already containing vegetation, and establishing one or more afforestation plots to increase forest/vegetation cover in the region. Establishing one or more afforestation plots can occur prior to or after providing an irrigation source. The one or more irrigation sources can include, but is not limited to, wastewater, treated effluent sewage, and storm runoff. The irrigation source can be a wastewater treatment plant. Embodiments of the method also include the use of plants having high moisture capacity and nutrient load capacity. Suitable plants that can be used according to the method include poplar, aspen, willow, cottonwood, eucalyptus, and reeds.

According to some embodiments, selected subregion can be at least about 1000 acres of contiguous or noncontiguous land located in regions that have experienced chronic water shortages and/or drought conditions, including Arkansas, Colorado, Hawaii, Idaho, Kansas, Nevada, New Mexico, Oklahoma, Texas and Utah.

According to other embodiments, natural resources include, but are not limited to, a plant product, including but not limited to, wood, wood pulp, timber, feedstock, fruit, fiber, and leaves. In other embodiments, the natural resource can be water.

Embodiments herein can also include assessing changes in precipitation and adjusting one or more of steps of methods disclosed herein that can include adjustments in the selecting the subregions to be targeted for induced precipitation recycling, adjustments in establishing the afforestation plots comprising a plurality of plants, adjustments in providing the irrigation sources, and adjustments in harvesting the natural resources.

Other embodiments can include a system of inducing precipitation capture and/or recycling. The system can include one or more regions that experience chronic water shortages or chronic drought conditions, a set of predetermined criteria for selecting one or more subregions to be targeted for induced precipitation recycling from the one or more regions that experience chronic water shortages or chronic drought conditions, one or more afforestation plots comprising a plurality of plants on at least a portion of the selected region, one or more irrigation sources for facilitating the growth of the plurality of plants in the selected subregion(s), and a means for harvesting one or more natural resources from the selected subregion(s). Some embodiments can include a set of predetermined criteria used to select one or more subregions to be targeted for induced precipitation recycling. Suitable selection criteria include proximity to a body of water, amount of vegetation present, proximity to an urban center, proximity to a hillside or mountain, proximity to an irrigation source, elevation, relative humidity, average annual rainfall, soil composition, water runoff characteristics, weather patterns, surface temperature, current utilization of land in the subregion, political stability, and economic stability.

Other features and advantages of the disclosure will be apparent from the following detailed description, and from the claims.

### BRIEF DESCRIPTION OF THE FIGURES

The following drawings form part of the instant specification and are included to further demonstrate certain aspects of particular embodiments herein. The embodiments may be better understood by reference to one or more of these drawings in combination with the detailed description presented herein.

FIG. 1A is an exemplary flowchart representing a method of inducing precipitation capture and/or recycling, according to one embodiment of the present disclosure.

FIG. 1B is a schematic representation of the induced precipitation recycling process, according to one embodiment of the present disclosure.

FIG. 1C is schematic representation of the process of afforestation, including urban afforestation, according to one embodiment of the present disclosure.

FIG. 1D is a schematic representation of the promotion of forest growth on desert slopes by induced precipitation recycling, according to one embodiment of the present disclosure.

FIGS. 2A and 2B are schematic representations of regions that experience chronic water shortages and/or drought conditions in the western United States (FIG. 2A) and throughout the world (FIG. 2B), according to certain embodiments of the present disclosure.

FIG. 3 is a schematic representation of the beneficial secondary effects of implementing induced precipitation recycling, according to one embodiment of the present disclosure.

### DETAILED DESCRIPTION

Embodiments of the present disclosure provide materials and methods for inducing precipitation capture and/or recycling, including, but not limited to, establishing afforestation plots and harvesting natural resources. Embodiments herein can include targeted development and implementation of an environmentally sustainable precipitation recycling program to ameliorate chronic regional water shortages and drought conditions.

Unless otherwise defined, all technical and scientific terms used herein have the same meaning as commonly understood by one of ordinary skill in the art to which this disclosure belongs. Although methods and materials similar or equivalent to those described herein can be used to practice the subject matter of the disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting. Other features and advantages of the disclosure will be apparent from the following detailed description, and from the claims.

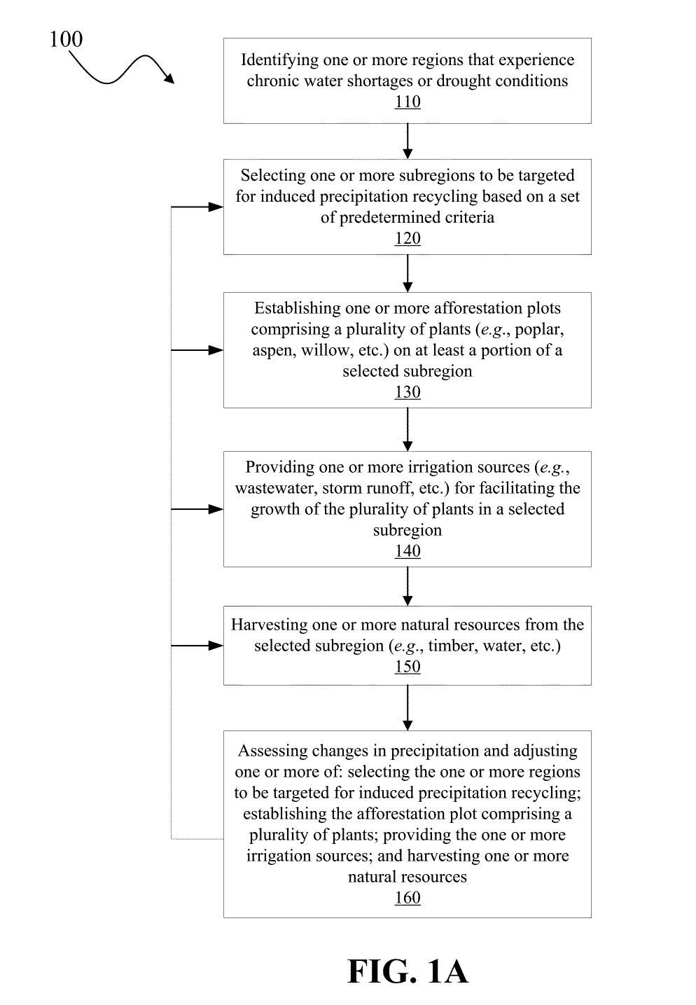

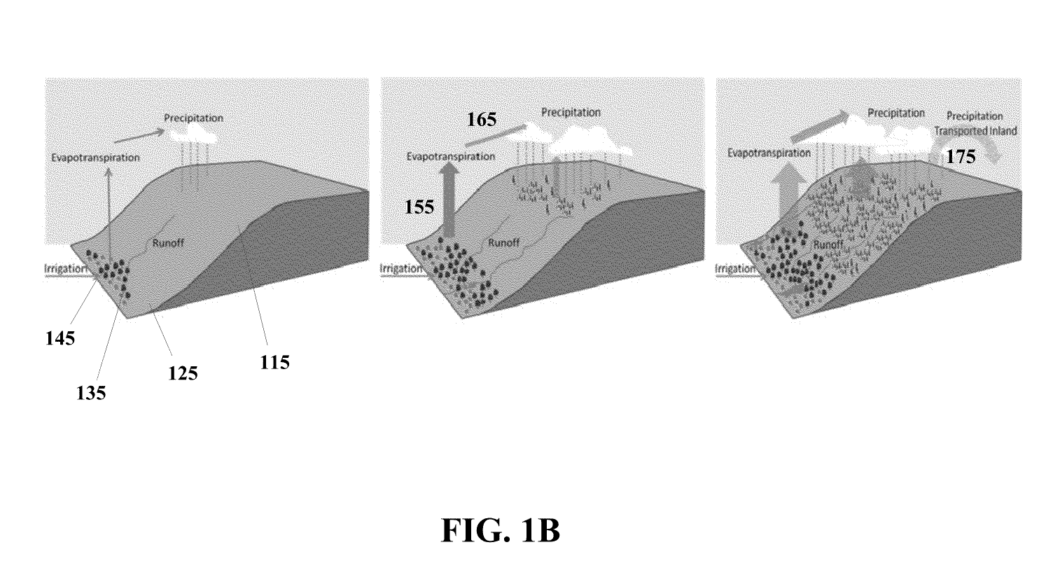

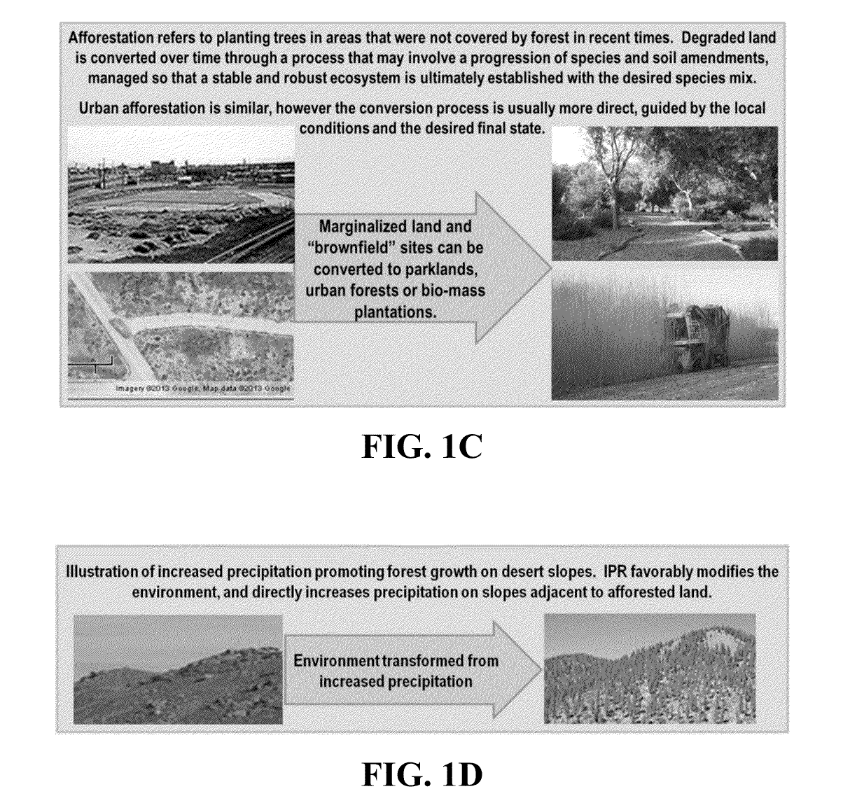

As illustrated in FIG. 1A at 100, a method of induced precipitation recycling according to the present disclosure includes identifying one or more regions that experience chronic water shortages or drought conditions (110) such as, for example, areas in and around the Los Angeles Basin in California, including the Gulf of California and the Salton Sea. Other regions of the United States that have experienced chronic water shortages or drought conditions include, but are not limited to, regions of Arkansas, Colorado, Hawaii, Idaho, Kansas, Nevada, New Mexico, Oklahoma, Texas and Utah. After identifying this region, the method can include selecting one or more subregions to be targeted for induced precipitation recycling (IPR) based on a set of predetermined criteria (120). The set of predetermined selection criteria can include any criteria that could impact the method of induced precipitation recycling in that selected subregion, including, but not limited to, criteria relating to geographical, environmental, social, and political variables. For example, the selection criteria could include one or more of: proximity to a body of water; amount of vegetation present; proximity to an urban center; proximity to a hillside or mountain; proximity to an irrigation source; elevation; relative humidity; average annual rainfall; soil composition; water runoff characteristics; weather patterns; surface temperature; current utilization of land in the subregion; political stability; and economic stability. In certain embodiments, criteria for selecting a subregion can be rated where certain preferential criteria is rated higher than other criteria, for example, proximity to a body of water or irrigation source, proximity to a hillside or mountain, soil composition can be rated higher than proximity to an urban center or economic stability. These ratings can depend on the region selected in order to identify a more optimum subregion.

After selecting one or more subregions to be targeted for induced precipitation recycling, the method can include establishing one or more afforestation plots comprising a plurality of plants on at least a portion of the selected subregion (130). The plurality of plants chosen for establishing an afforestation plot can include species of plants that can withstand high nutrient loads and/or high moisture capacity and/or are relatively drought resistant. Plants having these characteristics include, but are not limited to, poplar, aspen, willow, cottonwood, eucalyptus, reeds, and the like. The method can also include providing one or more irrigation sources to facilitate and support the growth of the plants in the afforestation plot (140). Suitable sources of irrigation can include those that do not put additional burdens on a region or a subregion's water supply. For example, sources of irrigation can include wastewater, treated effluent sewage, storm runoff, and the like. In some aspects, the irrigation source can be a wastewater treatment plant. Additionally, the steps of establishing an afforestation plot and providing an irrigation source can be performed in any order. For example, if a selected subregion already contains plants suitable for induced precipitation recycling, then the step of providing a source of irrigation may be performed prior to further establishing the afforestation plot. If a selected subregion contains little to no plant growth, then the step of establishing an afforestation plot may be performed prior to providing an irrigation source for the afforestation plot. The steps of establishing an afforestation plot and providing an irrigation source can also be performed simultaneously.

Methods of inducing precipitation recycling according to the present disclosure can include harvesting one or more natural resources from the selected subregion (150). When an afforestation plot and an irrigation source have been established, and the process of induced precipitation recycling is underway, natural resources can be harvested from the subregion. For example, one or more natural resources that can be harvested from the subregion include, but are not limited to, mature wood for lumber, wood pulp or feedstock for biofuel generation, fruit, fiber, leaves, and the like. Additionally, water vapor formed above the subregion can return to the subregion as rainfall or storm runoff. This water can also be harvested from the subregion and used as a source of irrigation for establishing afforestation plots in other subregions.

An additional part of certain methods for inducing precipitation recycling can include assessing changes in precipitation and adjusting one or more other steps of the method, including, for example, adjusting one or more of: selecting one or more additional and/or substitute regions to be targeted for induced precipitation recycling; establishing one or more additional and/or substitute afforestation plots comprising a plurality of plants; providing one or more additional and/or substitute irrigation sources; and harvesting one or more additional and/or substitute natural resources. In certain embodiments, changes in precipitation can be assessed in the selected subregion, or another region (e.g., an inland region) that has been affected or targeted by the method disclosed herein. Adjusting the steps of the method may increase the amount of induced precipitation and/or increase the natural resources harvested.

A schematic representation of induced precipitation recycling is illustrated in FIG. 1B. According to the method described above, a region 115 is targeted for inducing precipitation recycling because of its chronic exposure to water shortages and drought conditions. A subregion 125 is then selected based on a set of predetermined criteria, including, for example, elevation. As illustrated in FIG. 1B, the subregion can be located at the base of a hill or mountainside. An afforestation plot is then established in the subregion by planting suitable trees 135, or by cultivating the trees already present in the subregion. An irrigation source 145 is then provided or introduced to facilitate the growth of the trees in the afforestation plot.

Induced precipitation recycling harnesses existing environmental processes, including “precipitation recycling” (PR) and the “biotic pump” (BP). Generally, induced precipitation recycling requires the generation of large amounts of evapotranspiration (ET) from intensively irrigated, high density tree plantations, as well as with other reforestation projects. Increased evapotranspiration increases the moisture content of the air, making it more buoyant than surrounding drier air and causes it to rise (155). As the air rises and cools, water vapor condenses to form droplets and clouds, and ultimately rain. This further reduces the density of the rising air, creating a low-pressure region above the forested area. Typically, evaporation also occurs over the ocean, but not to the same extent over forests. When evaporation is stronger over the forest than over the ocean, a lower pressure region can be created over the trees. Moisture-laden air from the ocean is drawn towards the forest, generating wind which helps drive moisture further inland (165). Through repeated rainfall and subsequent evaporation, the moisture is recycled (through PR) in stages and moves even further inland. As a result, moisture can be consistently transported thousands of miles into the interior of a continent (175). Induced precipitation recycling establishes and strengthens these natural processes when conditions to sustain it do not exist.

Recognizing prevailing weather patterns and local favorable geography when selecting afforestation plots enhances the effects of induced precipitation recycling, and helps predict where precipitation can occur. This enables strategic planning for increasing both forest cover and runoff. As forest cover increases and progresses inland, other natural processes (related to inland atmospheric moisture transport) influence the weather and increase precipitation further. Ultimately, the environment can be favorably modified to strengthen these effects. This sets up a virtuous cycle of progressively increasing forest cover, greater amounts of precipitation (and runoff), and corresponding increases to the water supply, as illustrated in exemplary FIG. 1B.

As illustrated in FIG. 1C, and discussed above, afforestation refers to planting trees and other vegetation including, but not limited to, crops, in areas that were not previously covered by such trees or vegetation. Degraded land can be converted over time by using a stable process that may involve a progression of species and soil amendments, managed so that a stable and robust ecosystem is ultimately established with a desirable species mix. In some aspects, afforestation can be used to transform urban areas into more diverse ecosystems, usually involving a more direct conversion process guided, for example, by local conditions and the desired final state. In this manner, marginalized land such as brownfield sites can be converted to parklands, urban forests and/or biomass plantations.

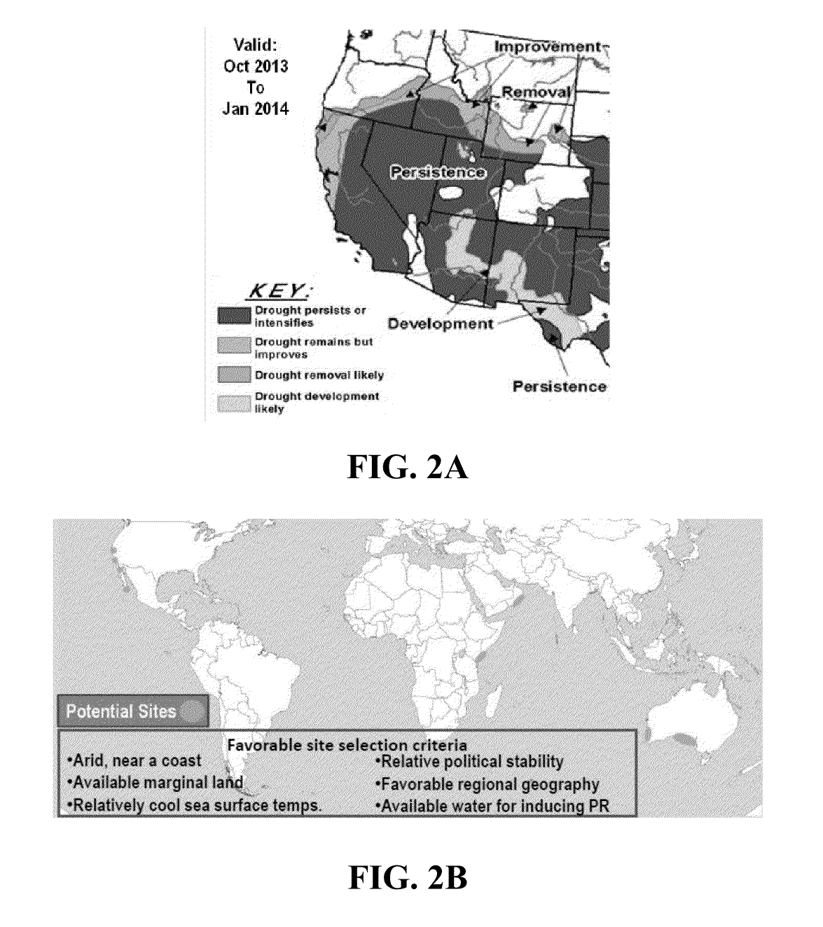

Another aspect of methods disclosed herein can include identifying one or more regions that experience chronic water shortages and/or drought conditions. As illustrated in FIG. 1D, for example, induced precipitation recycling can be used to promote forest or other plant growth on desert slopes. Induced precipitation recycling can favorably modify the surrounding environment and directly increase precipitation on the slopes adjacent to afforested land. As illustrated in FIG. 2A, these regions can include areas of the western United States. For example, regions having chronic water shortages and/or drought conditions include, but are not limited to, regions of the US such as Colorado, Idaho, Kansas, Nevada, New Mexico, Oklahoma, Texas and Utah. There are similar regions spread throughout the world. Many regions within these states are also projected to experience chronic water shortages and/or drought conditions in the future. Additionally, as illustrated in FIG. 2B, there are regions throughout the world that experience chronic water shortages and/or drought conditions that could be identified as region that would benefit from induced precipitation recycling.

Determining whether induced precipitation recycling can be successfully implemented in a given subregion can be done using a set of predetermined criteria. The predetermined set of criteria used to select the one or more subregions to be targeted for induced precipitation recycling may include one or more of: proximity to a body of water; amount of vegetation present; proximity to an urban center; proximity to a hillside or mountain; proximity to an irrigation source; elevation; relative humidity; average annual rainfall; soil composition; water runoff characteristics; weather patterns; surface temperature; current utilization of land in the subregion; political stability; and economic stability (FIG. 2B). Selection criteria may also be based on local laws, customs, political systems, and land or water rights. Generally, these and other criteria may be used to determine whether a given subregion can support the implementation of induced precipitation recycling or to determine the likelihood of success of increasing regional precipitation using induced precipitation recycling.

Part of the method of induced precipitation recycling can include establishing one or more afforestation plots on at least a portion of the subregion selected for induced precipitation recycling. In some aspects, the proposed environmental measures required to implement induced precipitation recycling in a given region or subregion involve the strategic location of afforestation projects within the region. Afforestation generally refers to planting trees in areas that were not covered by forest in recent times. Because much of the land available for transformation can be considered degraded (e.g., land with marginal economic value, brownfield zones, abandoned agricultural areas, and the like), re- and afforestation represents a valuable approach for improving the environmental quality of the land while rejuvenating regional PR. Degraded land can be converted over time through a process that may involve a progression of species and soil amendments, managed so that a stable and robust ecosystem is ultimately established with the desired species mix. For example, cultivars within an afforested plot can be established, which feature high-density shrub or tree stands optimized for processing wastewater. Given that waste water may be used as an irrigation source, plants or trees can be selected based on their ability to withstand high moisture content and high nutrient loads. The plants or trees that may be used include, but are not limited to, poplar, aspen, willow, cottonwood, eucalyptus, reeds and the like.

Another aspect of inducing precipitation recycling can include providing one or more sources of irrigation to facilitate the growth of the plants or trees in the region targeted for induced precipitation recycling. Irrigation sources may include, but are not limited to, wastewater, treated effluent sewage, storm runoff, and the like. In some aspects, the irrigation source is moderately treated sewage, with storm water runoff as an alternative source. With targeted selection of afforestation plots near wastewater sources, the necessary transport infrastructure for rerouting wastewater for irrigation can be minimized. If processed sewage is used, for example, fertilizer and soil treatments are significantly reduced due to the presence of nitrates, phosphates and other nutrients in the effluent, which often forms a well-balanced plant fertilizer. This significantly reduces costs for afforestation in nutrient-poor soils, which will often be encountered when selecting available land in this heavily populated region (e.g., urban areas). These considerations further support developing the initial re- and afforestation locations as wastewater treatment plantations. Existing plantations that use wastewater processed through primary or secondary treatment levels can serve as a guide for development.

Inducing precipitation recycling harnesses natural environmental processes to ameliorate regional water shortage as well as producing synergistic ecological side effects that can be highly beneficial for a region. These beneficial effects can be ecosystem services to provide a supplemental source of income, and they can add value to a region. Although life-cycle costs for IPR are anticipated to be much lower than other proposed options for increasing the current water supply, these additional income streams can help cover initial development, startup and research costs, and potentially generate operating profits.

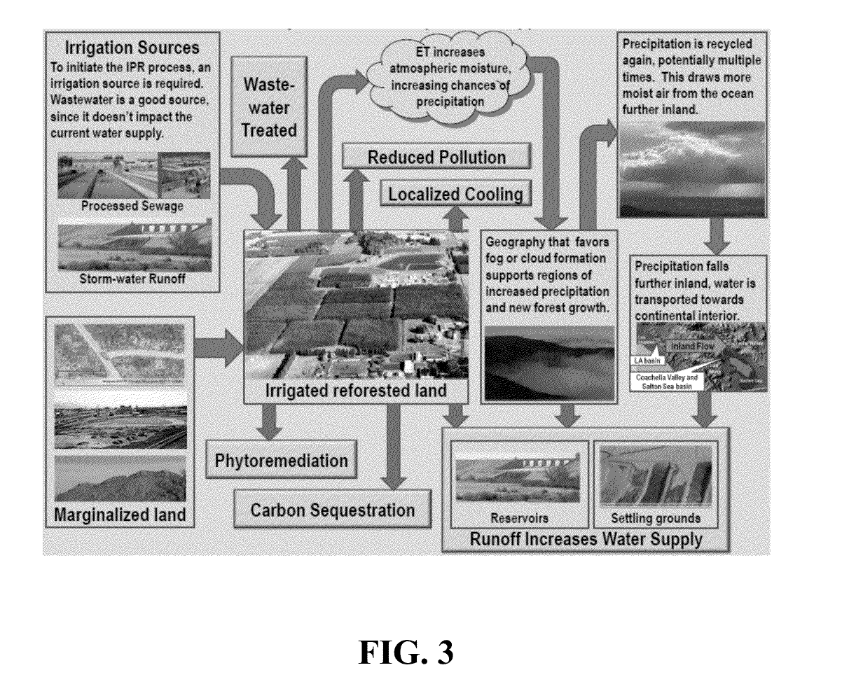

Some of the beneficial side effects, or co-benefits, of implementing induced precipitation recycling are illustrated in FIG. 3. For example, induced precipitation recycling can provide means for nutrient management. Wastewater streams typically carry deleterious agents such as pathogens (e.g., bacteria) and elevated levels of byproducts/agents for example, nitrates and phosphates, which are responsible for eutrophication (“dead zones”) in lakes and oceans. Forests and vegetation cover can ameliorate byproducts/agents loading and help purify available water resources. Induced precipitation recycling can also provide methods or means for carbon sequestration, as forests and forest soils naturally sequester carbon. Induced precipitation recycling can also provide methods or means for storm water management. Any storm runoff diverted to reservoirs for irrigation purposes or released over forested areas naturally reduces potential downstream flooding and peak loads on the sewer system. Induced precipitation recycling can also provide means for groundwater recharge. Storm runoff or processed sewage further treated by afforested areas (and potentially designed wetlands as well) may help recharge local aquifers through infiltration. Induced precipitation recycling can also provide means for economic opportunities, including the creation of new jobs. Induced precipitation recycling can also provide means for providing natural resources, including forestry products and purified water. Trees can be harvested for lumber, pulp or wood fiber, and bio-fuel feedstock, and water can be harvested and used, for example, to irrigate other afforestation regions. Induced precipitation recycling can also provide means for the reduction of airborne pollutants. Trees, and rainfall, help remove various pollutants from the air such as ozone, sulfur dioxide, nitrogen dioxide, particulates, and others. Induced precipitation recycling can also provide means for bioremediation or phytoremediation of waste sites. Certain trees and plants can bio-accumulate, degrade, or render harmless contaminants such as metals, pesticides, solvents, explosives, and crude oil and its derivatives in soil over time. Induced precipitation recycling can also provide means for localized atmospheric cooling. Evapotranspiration can provide a localized cooling effect directly from the evaporation process, and indirectly where cloud-cover increases.

As more afforestation plots are established and irrigated, the sum total of increases in evapotranspiration becomes more significant. In some aspects, test afforestation plots can be established and used as models and simulations to guide the selection and implementation of new sites to maximize potential precipitation increases. The data and information obtained from these test plots can then be used to make adjustments in the method of induced precipitation recycling already in use in a given region, and/or to make adjustments when implementing induced precipitation recycling in new regions.

For example, when cultivars on a test plot have developed enough to generate detectable levels of evapotranspiration, sensors can track the evolving shape and propagation direction of the region of increased moisture to help characterize its general behavior. GPS water vapor tomography using a locally deployed GPS sensor network can provide the means for assessing how the induced evapotranspiration interacts with the local environment, and pressure sensors can be used to quantify changes in atmospheric pressure before and after establishing afforestation test plots. Additionally, new and existing analysis methodologies (e.g., using remote sensing, precipitation and runoff data) can be used and selected based on relevance and utility to the specifics of induced precipitation recycling in a given location. These will provide analytical support to assess, for example, the amount of vapor transported downstream from an evapotranspiration source and initial estimates of evapotranspiration flow dispersion parameters and propagation direction.

Based on observational data, as well as obtaining quantitative and qualitative metrics associated with various environmental parameters affecting a given test plot, improvements and adjustments can be made to maximize induced precipitation recycling. For example, one or more of the following assessments can be made in order to update processes for making various improvements to the test plot: 1) tracking evapotranspiration generated from specific sources; 2) predicting/modeling observed effects using various algorithms and simulations; 3) determining where the recycled evapotranspiration falls as precipitation; 4) determining how existing microclimates are modified with induced precipitation recycling; 5) determining how much evapotranspiration is required to achieve measureable precipitation increases; 6) determining how much new forest growth from induced precipitation recycling is required to initiate a “biotic pump” effect; 7) determining whether existing plant species have adapted to a given environmental alteration; 8) determining the ideal mix of various plant species for a given test plot; 9) determining the limiting resources besides water that affect the growth of plant species; and 10) determining how to manage the growth of new plant species in a given test plot. In some aspects, these and other assessments will inform how the various environmental parameters or factors discussed in the present disclosure should be weighted in determining where induced precipitative recycling will be implemented. For example, proximity to a wastewater irrigation source or whether soil composition favors a certain type of vegetation may be weighted more significantly than the water runoff characteristics or local weather patterns, as would be recognized by one or ordinary skill in the art based on the present disclosure.

Information and data from test plots can provide an analytical basis for predicting the impact of increased evapotranspiration on local and regional precipitation events. This facilitates the implementation of similar large-scale projects in other locations. Predicting how proposed afforestation and reforestation will contribute to regional precipitation patterns provides insight into how new evapotranspiration sources can be strategically located to create the desired induced precipitation recycling effect. If strong enough, the adverse conditions that maintain a desert can be overcome. To ensure that robust ecosystems are developed, adequate plant diversity featuring native species may be essential (actual species mix will depend on the “target” climate zone of the transformed region). In some aspects, afforestation plots can be established so that they comprise both native plant species and non-native plant species, with the overall goal of establishing an ideal mix that maximizes the effect of induced precipitation recycling. Generally, increasing regional precipitation using induced precipitation recycling can create a virtuous cycle of progressively increased levels of precipitation with corresponding increases in total forested area. Excess runoff may be captured in new reservoirs, becoming available for use in the region or to establish other afforestation plot in other regions

### EXAMPLES

Examples of the present disclosure are included to demonstrate certain embodiments presented herein. It should be appreciated by those of skill in the art that the techniques disclosed in the examples that follow represent techniques discovered to function well in the practices disclosed herein. However, those of skill in the art should, in light of the present disclosure, appreciate that many changes can be made in the certain embodiments which are disclosed and still obtain a like or similar result without departing from the spirit and scope herein.

### Example 1

### The Implementation of Induced Precipitation Recycling within the Los Angeles Region

The method of induced precipitation recycling, as described herein, can be implemented within the Los Angeles region using a phasic approach, including a pilot or proof-of-concept phase; a expansion phase; and a large-scale implementation phase. The natural orographic features of the Los Angeles Basin area (e.g., hills, mountains) increase the probability that a greater share of evapotranspiration will condense and precipitate locally, increasing secondary forest growth. Since the Los Angeles region is a region with limited water availability, using part of the current water supply as an irrigation source is untenable.

### Pilot Phase

Therefore, the initial pilot phase will utilize wastewater for irrigation. The wastewater source will be moderately treated sewage, with storm water runoff as the alternative. Land selected for afforestation typically will not have alternative agricultural or ecological potential (and is probably unsuited for these purposes), so degradation of soil quality would be a minor concern. Soil quality can improve over time as a result of afforestation, waste-stream fertilization and bioremediation. Irrigation is provided by wastewater that is currently discarded as a liability, so there is no reduction in downstream water availability. The afforestation plot within the subregion will be heavily irrigated, so there will likely be no increase in salinity due to upwelling of saline groundwater or intrusion of seawater, although conditions will be monitored to ensure this problem does not arise. Additionally, Southern California typically receives enough precipitation to periodically flush the soil and reduce salinization.

The coverage of the pilot phase can be on the order of 1000 contiguous acres (e.g., 1.6 square miles or 4 square kilometers), although 1000 noncontiguous acres would also work. In some aspects, modern coastal cities do not have large amounts of vacant land available; however, depending on local environment conditions (e.g., local geography, availability of wastewater, etc.), large-scale afforestation plots of several dozen, noncontiguous miles inland can be sufficient for induced precipitation recycling. Potential sites of the necessary size near wastewater sources in the LA region have been identified, and availability will be determined during the preliminary planning stage. The prevailing local weather patterns and geography provide a reasonable initial estimate of where precipitation from additional evapotranspiration might fall. The high evapotranspiration rates from a plantation of this size are consistent with the primary goal of increasing atmospheric moisture levels in a localized region, facilitating observation with the installation of sensors. This pilot phase enables research to be performed, and serves to lay the groundwork for further investment and development.

In some aspects, establishment of a 1000 acre induced precipitation recycling plantation capable of processing about 2 million gallons of wastewater per day is projected to cost around 5 million dollars for the first five years of operation. The cost for plantations of a different size can be conservatively assumed to scale accordingly. Additionally, estimates can be made of potential revenues from sales of biofuel feedstock (assuming a local market exists), which may exceed overall project costs (including loan payments) after a period of 10 years. Revenues from environmental services (e.g., primarily wastewater treatment and carbon sequestration) can also be estimated. In addition, intangible long-term benefits such as bioremediation, localized atmospheric cooling, and the benefits discussed previously can further increase the overall impact and value of an induced precipitation recycling program in a given location.

As summarized in Table 1, several project development metrics for the pilot phase of this project are provided.

TABLE 1

| Assessment Metric | Goal (per 1000 acres) |
|---|---|
| Amount of waste-water treated, converted to ET | 2.67 million gallons |
| | per day |
| Total amount of Carbon Sequestered at | 1670-3270 metric tons |
| stand maturity | |
| Characterized ET flow direction, dispersion, etc.) | Statistics from data |
| | analysis |
| Value of biofuel feedstock produced (first harvest | $662K (USD) |
| conservative estimate from budget model) | |
| Maximum nitrate levels in runoff or groundwater | <10 mg per liter |
| Operational costing models | Correlated to actual |
| | financials |
| Estimate of ET recycled as precipitation in LA | Statistics from |
| basin, and beyond | observations |
| Reductions in soil contaminant concentration | TBD (if applicable) |

These project development metrics will be updated during a detailed design phase for a given test plot or demonstration plantation. Depending on the latitude and climate, maximum irrigation rates may be lower or higher than those used on existing plantations. Also, the listed carbon sequestration values associated with willow coppice are considerably lower than those estimated for other species and can vary based on the actual cultivar species. However, these values provide a representative starting point for project development goals.

### Expansion Phase

Once the pilot phase has demonstrated the general viability of the use of induced precipitation recycling in the Los Angeles region test plot, additional irrigated afforestation plots will be established within the Los Angeles region. As with the pilot phase, processed sewage will be used as an irrigation source for these additional locations, although another potential source of irrigation that will be considered is storm runoff. The regional storm drainage system was developed to prevent recurrences of devastating floods, and channels runoff directly to the ocean. On a dry day, about 100 million gallons pass through the Los Angeles city system. On a rainy day, the amount can increase to as much as 10 billion gallons. Some of this water can be captured by infiltration through vegetated bio-swales, permeable streets or parking lots, and other green infrastructure. Evapotranspiration produced by these features supplements the moisture supplied by the waste water treatment plant, for example, while the vegetation concurrently enhances infiltration helping to directly recharge ground water supplies. Settling grounds currently capture some storm runoff to recharge aquifers, but the Los Angeles Water Replenishment District (Southern California Engineering Survey and Report of 2013) estimated that 96,000 additional acre-feet of water were required for 2013 to replenish the Los Angeles regional ground water supply, at a total cost of almost 38 million dollars. Any increase to the amount captured reduces how much water needs to be imported.

### Large-Scale Implementation

As more irrigated afforestation plots are established, and as methods storm water capture are developed, evapotranspiration increases become more significant. Although there is a limited supply of available land within the Los Angeles basin itself, undeveloped land is more plentiful further from the coast. Much larger afforestation plots, plantations, and planned wetlands can potentially be developed in the arid lands, for example, below the Cajon pass north of San Bernardino, east of Riverside or near the San Gorgonio pass. This may require considerable upfront investment in infrastructure, so research performed during the pilot phase will be important for further development.

Site preparation becomes important during this phase since a much larger region is being targeted, and trees growing on the slopes will not receive processed sewage and the nutrients this provides. Composted waste, organic materials and other soil treatments can be used to improve soil quality, and fertilizers can be applied to support establishment of the primary forest cover. This type of intensive preparation can be expensive at any location, and becomes difficult in rougher terrain. It may therefore be focused at key locations where secondary afforestation will enhance natural expansion of new growth. In more remote locations, transitional species will be established to help improve soil quality through natural processes as precipitation levels increase, prior to introducing the desired mature stage species. In some aspects, secondary afforestation has the potential for sequestering more carbon than the primary afforestation sites.

If enough new forest land is established, it is anticipated that an even larger region will benefit. Precipitation can be recycled multiple times as moisture travels further inland, so a portion of the recycled evapotranspiration will be carried beyond the mountains surrounding the Los Angeles basin. For example, precipitation increases at higher elevations on the mountainous slopes of the San Bernardino Mountains, and potentially on dryer slopes bordering the eastern side of the Coachella valley, would partially transform the desert environment. Increased runoff to the valley will reduce the imported water requirements necessary to support civic and agricultural needs. This can even support mitigation efforts for the environmental challenges facing the Salton Sea. The Colorado River basin may also benefit, especially if reforestation efforts were expanded to more regions besides the Los Angeles basin (i.e., more extensive afforestation along the Pacific coast). If enough of the burden on the Colorado River is reduced, a portion of the saved water could be allocated to flow through the entire natural watercourse. This would support habitat restoration efforts within the Colorado River delta and the upper regions of the Gulf of California.

Initial financial outlays to develop an induced precipitation recycling project are anticipated to be competitive with those for other options proposed to increase the current water supply (e.g., importation, desalination, etc.), based on first order estimates. Establishment of an induced precipitation recycling plantation capable of processing 2 million gallons of wastewater a day is projected to be around $5 million for the first five years of operations, and costs for additional capability can be conservatively assumed to scale accordingly. The most significant financial advantage with induced precipitation recycling plantations is the revenues generated from marketing beneficial side effects and harvested biomass. The budget model indicates the potential to generate revenues from biofuel feedstock alone that exceed overall project costs (including loan payments) after a period of 10 years. In addition, intangible long-term benefits such as urban renewal, localized atmospheric cooling, and the creation of new forest and recreational land further increases the utility and attractiveness of this project.

In some aspects, “gray water” and/or processed sewage water can be recycled directly for groundwater recharge. For example, a sewage effluent recycling plant was built in Orange County, California at a cost of $481 million. Ongoing costs are about $850 per acre foot, which is lower than current costs to import water. This plant can produce up to 100 million gallons of water per day, based on available supply of effluent. This represents a consistent source of additional water from directly treated wastewater. And if carbon sequestration is included as part of a climate change mitigation strategy, induced precipitation recycling plantations can be an integral part of the solution.

The induced precipitation recycling project described herein can be readily transferred to other locations, and can be scaled and customized to suit the local conditions. The Los Angeles basin was proposed for this project due to the realized need for a secure water supply, the availability of large quantities of wastewater for irrigation, and the fortuitous location near major universities and existing infrastructure. Other potential locations exist anywhere that arid regions are adjacent to oceans. Very similar projects using the same approach for each phase could be implemented in areas around San Francisco Bay (e.g., Oakland or San Jose), the Sacramento delta or San Diego. Other locations around the world will require modifications to the project based on availability of an irrigation source to initiate the induced precipitation recycling process. Some modifications to the approach will probably also be necessary based on local laws, customs, political systems and land or water rights.

Additional factors or parameters that can affect the large-scale implementation of induced precipitation recycling include, but are not limited to, whether existing plant species have the resilience/adaptability to withstand the environmental changes (not just the precipitation regime, but also changes to soil moisture and temperature levels, competing vegetation, etc.); determining the necessity of planned cultivation to ensure that robust ecosystems are developed; maintaining adequate plant diversity featuring native species (actual species mix will depend on the “target” ecology of the transformed region) to help minimize management and maintenance costs; maintaining adequate seed and cultivar stocks should be available to support the desired schedule; and assessing the need for composted waste, organic materials and other soil treatments to improve soil quality.

The present disclosure, in various aspects, embodiments, and configurations, includes components, methods, processes, systems and/or apparatus substantially as depicted and described herein, including various aspects, embodiments, configurations, sub combinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed:

1. A method of increasing precipitation using induced precipitation recycling, the method comprising:
identifying one or more regions that experience chronic water shortages or chronic drought conditions;
selecting one or more subregions to be targeted for induced precipitation recycling from the one or more regions that experience chronic water shortages or chronic drought conditions based on predetermined criteria;
establishing one or more afforestation plots comprising a plurality of plants on at least a portion of the selected subregion or subregions; and
providing one or more irrigation sources for facilitating the growth of the plurality of plants in the selected subregion or subregions.

2. The method of claim 1, further comprises harvesting one or more natural resources from the selected subregion or subregions.

3. The method of claim 1, wherein the predetermined criteria to select the one or more subregions to be targeted for induced precipitation recycling includes one or more of:
proximity to a body of water, amount of vegetation present, proximity to an urban center, land available for afforestation, proximity to a hillside or mountain, proximity to an irrigation source, elevation, relative humidity, average annual rainfall, soil composition, native plant species present, water runoff characteristics, weather patterns, surface temperature, current utilization of land in the subregion, political stability, and economic stability.

4. The method of claim 1, wherein establishing the one or more afforestation plots includes planting a plurality of plants on at least a portion of the one or more subregions having no vegetation.

5. The method of claim 1, wherein establishing the one or more afforestation plots includes planting a plurality of native and non-native plants on at least a portion of the one or more subregions already containing vegetation.

6. The method of claim 1, wherein establishing the one or more afforestation plots includes increasing forest cover in the region.

7. The method of claim 1, wherein the step of establishing the one or more afforestation plots occurs prior to providing an irrigation source.

8. The method of claim 1, wherein the step of establishing the one or more afforestation plots occurs after providing an irrigation source.

9. The method of claim 1, wherein the one or more irrigation sources comprises at least one of wastewater, treated effluent sewage, and storm runoff.

10. The method of claim 1, wherein the one or more irrigation sources is a wastewater treatment plant.

11. The method of claim 1, wherein the plurality of plants includes plants having high moisture capacity and nutrient load capacity.

12. The method of claim 1, wherein the plurality of plants includes at least one of a poplar, aspen, willow, cottonwood, eucalyptus, and reeds.

13. The method of claim 1, wherein the selected subregion is at least about 1000 acres.

14. The method of claim 1, wherein the selected subregion is in Arkansas, Colorado, Hawaii, Idaho, Kansas, Nevada, New Mexico, Oklahoma, Texas and Utah.

15. The method of claim 1, wherein the selected subregion is in Los Angeles County.

16. The method of claim 1, wherein the one or more natural resources is a plant product.

17. The method of claim 1, wherein the one or more natural resources is water.

18. The method of claim 1, wherein the one or more natural resources comprises one or more of wood, wood pulp, timber, feedstock, fiber, and leaves.

19. The method of claim 1, wherein the method further comprises assessing one or more environmental factors associated with an area subjected to induced precipitation recycling and adjusting one or more of:
selecting one or more additional or substitute subregions to be targeted for induced precipitation recycling, establishing one or more additional or substitute afforestation plots comprising a plurality of plants, providing one or more additional or substitute irrigation sources, and harvesting one or more additional or substitute natural resources.

20. A system of inducing precipitation recycling, the system comprising:
one or more regions that experience chronic water shortages or chronic drought conditions;
a set of predetermined criteria for selecting one or more subregions to be targeted for induced precipitation recycling from the one or more regions that experience chronic water shortages or chronic drought conditions;
one or more afforestation plots comprising a plurality of plants on at least a portion of the selected region;
one or more irrigation sources for facilitating the growth of the plurality of plants in the selected subregion(s); and
a means for harvesting one or more natural resources from the selected subregion(s).

21. The system of claim 19, wherein the predetermined set of criteria used to select one or more subregions to be targeted for induced precipitation recycling includes one or more of:
proximity to a body of water, amount of vegetation present, proximity to an urban center, land available for afforestation, proximity to a hillside or mountain, proximity to an irrigation source, elevation, relative humidity, average annual rainfall, soil composition, native plant species present, water runoff characteristics, weather patterns, surface temperature, current utilization of land in the subregion, political stability, and economic stability.
